(19) United States
(12) Patent Application Publication
(10) Pub. No.: US 2017/0299118 A1
(43) Pub. Date: Oct. 19, 2017

(54) METHOD FOR REDUCING NATURAL EVAPORATION RATE OF LNG STORAGE TANK

(71) Applicant: DAEWOO SHIPBUILDING & MARINE ENGINEERING CO., LTD., Seoul (KR)

(72) Inventors: Jung Sub SHIN, Seoul (KR); Seong Woo PARK, Geoje-si (KR); Beom Seok HWANG, Suwon-si (KR); Joong Kyoo KANG, Geoje-si (KR)

(73) Assignee: DAEWOO SHIPBUILDING & MARINE ENGINEERING CO., LTD., Seoul (KR)

(21) Appl. No.: 15/513,443

(22) PCT Filed: Sep. 24, 2015
(86) PCT No.: PCT/KR2015/010083

§ 371 Date: Mar. 22, 2017

(30) Foreign Application Priority Data
Sep. 26, 2014 (KR) 10-2014-0128954

(51) Int. Cl. F17C 1/12; F17C 13/00

(52) U.S. Cl. CPC F17C 1/12; F17C 13/001; F17C 2221/033; F17C 2203/0391; F17C 2203/0379; F17C 2265/03; F17C 2203/0682

(57) ABSTRACT

Disclosed is a method for reducing the natural evaporation rate of an LNG storage tank. The method for reducing the natural evaporation rate of an LNG storage tank comprises the steps of: manufacturing an LNG storage tank including a primary insulation layer and a secondary insulation layer; connecting one end of a second vacuum hose to the secondary insulation layer; connecting the other end of the second vacuum hose to a vacuum pump; and actuating the vacuum pump so as to lower the internal pressure of the secondary insulation layer. The method enables the inside of the secondary insulation layer to be a vacuum, and thus lowers the moisture content of plywood included in the secondary insulation layer.

### TECHNICAL FIELD

The present invention relates to a method for reducing the boil-off rate of an LNG storage tank and, more particularly, to a method for reducing the boil-off rate of LNG stored in an LNG storage tank by improving insulation performance of the LNG storage tank.

### BACKGROUND ART

With growing global interest in eco-friendly businesses, demand for clean fuel, which can replace existing energy sources such as petroleum and coal, is increasing. In this situation, natural gas is used in various fields as a main energy source having cleanliness, stability and convenience. Unlike the US and Europe, where natural gas is directly supplied through pipelines, Korea introduced liquefied natural gas (hereinafter, “LNG”) obtained by liquefying natural gas at an extremely low temperature and has supplied LNG to consumers. Thus, the demand for an LNG storage tank is increasing along with increase in domestic natural gas demand.

LNG is obtained by cooling natural gas to an extremely low temperature (about −163° C.) and is suitable for long-distance transportation by sea since LNG is significantly reduced in volume, as compared with natural gas in a gaseous state. LNG carriers are designed to carry liquefied gas to an onshore source of demand and, for this purpose, include a storage tank capable of withstanding ultra-low temperatures of LNG.

Such a storage tank is divided into an independent tank-type and a membrane-type depending on whether the weight of cargo is directly applied to an insulator. The membrane-type storage tank is divided into a GTT NO 96-type and a Mark III-type, and the independent tank-type storage tank is divided into a MOSS-type and an IHI-SPB-type. The GTT NO 96-type and GTT Mark III-type were formerly called a GT type and a TGZ type. After Gas Transport (GT) and Technigaz (TGZ) were renamed to GTT (Gaztransport & Technigaz) in 1995, the GT type and the TGZ type have been referred to as the GTT NO 96-type and the GTT Mark III-type, respectively.

For a membrane-type LNG storage tank, insulation performance is secured by an insulation box or an insulation panel. Plywood is widely used as a material for an insulating box or an insulating panel. Plywood is evaluated as the most competitive material among materials that can function as a load bearing structural material, as an insulator for preventing heat penetration from the outside, and as a container for storing other materials.

Generally, plywood has a water content of about 10% to 15%. As the water content decreases, the thermal conductivity of the plywood is reduced. When the thermal conductivity of the plywood is reduced, the thermal conductivity of the insulation box or the insulation panel is also reduced, thereby causing increase in insulation performance of the storage tank.

### DISCLOSURE

### Technical Problem

Plywood used in typical LNG storage tanks has a water content of 10% to 15%, and has a higher thermal conductivity than an insulation box or an insulation panel including the plywood. Thus, the plywood used in typical LNG storage tanks contributes to deterioration in insulation performance of the insulation box or the insulation panel and thus increase in boil-off rate (BOR) of LNG stored in the storage tank.

Embodiments of the present invention have been conceived to solve such a problem in the art and provide a method for reducing the boil-off rate of an LNG storage tank, which includes operating a vacuum pump to reduce an internal pressure of a heat-insulating layer of the LNG storage tank.

### Technical Solution

In accordance with one aspect of the present invention, a method for reducing a boil-off rate of an LNG storage tank includes: fabricating an LNG storage tank including a primary heat-insulating layer and a secondary heat-insulating layer; connecting one end of a second vacuum hose to the secondary heat-insulating layer; connecting the other end of the second vacuum hose to a vacuum pump; and operating the vacuum pump to reduce the internal pressure of the secondary heat-insulating layer, wherein an inner side of the secondary heat-insulating layer is evacuated to a vacuum to reduce the water content of plywood contained in the secondary heat-insulating layer.

The method may further include: connecting one end of a first vacuum hose to the primary heat-insulating layer of the LNG storage tank; connecting the other end of the first vacuum hose to the vacuum pump; and operating the vacuum pump to reduce the internal pressure of the primary heat-insulating layer, wherein the inside of the primary heat-insulating layer may be evacuated to a vacuum to reduce the water content of plywood contained in the primary heat-insulating layer, and the internal pressure of the primary heat-insulating layer may be maintained to be higher than the internal pressure of the secondary heat-insulating layer during performing the method for reducing the boil-off rate of the LNG storage tank.

The vacuum pump may include a plurality of vacuum pumps, each of which may be connected to the other end of the first vacuum hose and the other end of the second vacuum hose.

The first vacuum hose and the second vacuum hose may include the same number of first vacuum hoses as the vacuum pumps and the same number of second vacuum hoses as the vacuum pumps, respectively, such that the other ends of the first vacuum hoses and the other ends of the second vacuum hoses are connected to the vacuum pumps in a one-to-one manner.

One end of the first vacuum hose may be connected to the primary heat-insulating layer; one end of the second vacuum hose may be connected to the secondary heat-insulating layer; the other end of the first vacuum hose may be branched off into the same number of portions as the vacuum pumps to be connected to the respective vacuum pumps; and the other end of the second vacuum hose may be branched off into the same number of portions as the vacuum pumps to be connected to the respective vacuum pumps.

The other end of the first vacuum hose may be connected to a first vacuum pump and the other end of the second vacuum hose may be connected to a second vacuum pump.

The first vacuum pump and the second vacuum pump may include a plurality of first vacuum pumps and a plurality of second vacuum pumps, respectively, wherein each of the first vacuum pumps may be connected to the other end of the first vacuum hose and each of the second vacuum pumps may be connected to the other end of the second vacuum hose.

The first vacuum hose may include the same number of first vacuum hoses as the first vacuum pumps such that the other ends of the first vacuum hoses are connected to the first vacuum pumps in a one-to-one manner, and the second vacuum hose may include the same number of second vacuum hoses as the second vacuum pumps such that the other ends of the second vacuum hoses are connected to the second vacuum pumps in a one-to-one manner.

One end of the first vacuum hose may be connected to the primary heat-insulating layer; one end of the second vacuum hose may be connected to the secondary heat-insulating layer; the other end of the first vacuum hose may be branched off into the same number of portions as the first vacuum pumps to be connected to the respective first vacuum pumps; and the other end of the second vacuum hose may be branched off into the same number of portions as the second vacuum pumps to be connected to the respective second vacuum pumps.

The water content of plywood may be controlled by adjusting a period of time for which internal pressures of the primary heat-insulating layer and the secondary heat-insulating layer are maintained constant.

The method may further include: supplying a gas having a temperature higher than or equal to room temperature to the primary heat-insulating layer when the temperature of plywood contained in the primary heat-insulating layer drops below zero, and supplying a gas having a temperature higher than or equal to room temperature to the secondary heat-insulating layer when the temperature of plywood contained in the secondary heat-insulating layer drops below zero.

The gas may include any one of argon, helium, and nitrogen.

At least one of the primary heat-insulating layer and the secondary heat-insulating layer may be maintained under vacuum after the water content of the plywood is reduced.

The method may further include supplying a gas to at least one of the primary heat-insulating layer and the secondary heat-insulating layer after the water content of the plywood is reduced.

The gas may include any one of argon, helium, and nitrogen.

In accordance with another aspect of the present invention, a method for reducing a boil-off rate of an LNG storage tank includes: fabricating an LNG storage tank comprising a heat-insulating layer; connecting one end of a vacuum hose to the heat-insulating layer; connecting the other end of the vacuum hose to a vacuum pump; and operating the vacuum pump to reduce the internal pressure of the heat-insulating layer, wherein the inside of the heat-insulating layer is evacuated to a vacuum to reduce the water content of plywood contained in the heat-insulating layer.

In accordance with a further aspect of the present invention, a vacuum apparatus includes: a vacuum hose having one end connected to a heat-insulating layer of an LNG storage tank; and a vacuum pump connected to the other end of the vacuum hose, wherein the vacuum pump is operated to evacuate an inner side of the heat-insulating layer to a vacuum to reduce the water content of plywood contained in the heat-insulating layer.

The vacuum apparatus may further include a vacuum gauge measuring a pressure inside the heat-insulating layer.

The vacuum apparatus may further include a vacuum filter installed on the vacuum hose to filter out impurities.

### Advantageous Effects

Embodiments of the present invention provide a method for reducing a boil-off rate of an LNG storage tank, which can reduce the water content of plywood used in the LNG storage tank, thereby increasing thermal conductivity of an insulation box and insulation panel including the plywood while increasing insulation performance of the LNG storage tank to reduce the BOR of LNG stored in the storage tank.

An LNG storage tank stores LNG in a liquid state and the LNG is easily vaporized due to a very low vaporization point thereof (about −162° C.). Thus, avoiding vaporization of the LNG during transportation is one of the most important challenges in design of the LNG storage tank. Therefore, the ability to reduce the BOR of LNG in the LNG storage tank means that LNG transport can be performed efficiently and economically.

In addition, embodiments of the present invention provide a method for reducing a boil-off rate of an LNG storage tank, which can use plywood, which is the most competitive material among materials capable of functioning as a structural material, an insulator and the like, as an insulator for the LNG storage tank, instead of other materials having a higher water content than plywood, while reducing the water content of the plywood, thereby reducing thermal conductivity of the LNG storage tank while adopting advantages of plywood.

Further, as in a typical method, plywood can be subjected to vacuum drying after the LNG storage tank is constructed, whereby the water content of the plywood can be reduced easily and quickly.

### DESCRIPTION OF DRAWINGS

FIG. 1 is a schematic side view of an LNG storage tank and vacuum apparatus according to a first embodiment of the present invention.

FIG. 2 is a schematic side view of an LNG storage tank and vacuum apparatus according to a second embodiment of the present invention.

FIG. 3 is a state diagram of water according to changes in temperature and pressure.

FIG. 4 is a graph depicting change in pressure inside a heat-insulating layer according to an exemplary embodiment of the present invention.

FIG. 5 is a flowchart of a method for reducing a boil-off rate of an LNG storage tank according to a first embodiment of the present invention.

FIG. 6 is a flowchart of a method for reducing a boil-off rate of an LNG storage tank according to a second embodiment of the present invention.

### EMBODIMENTS

Hereinafter, embodiments of the present invention will be described with reference to the accompanying drawings. A method for reducing a boil-off rate of an LNG storage tank according to the following embodiments may be applied to all marine structures designed for LNG transportation. In addition, it should be understood that the present invention is not limited to the following embodiments, and that various modifications, substitutions, and equivalent embodiments can be made by those skilled in the art without departing from the spirit and scope of the present invention.

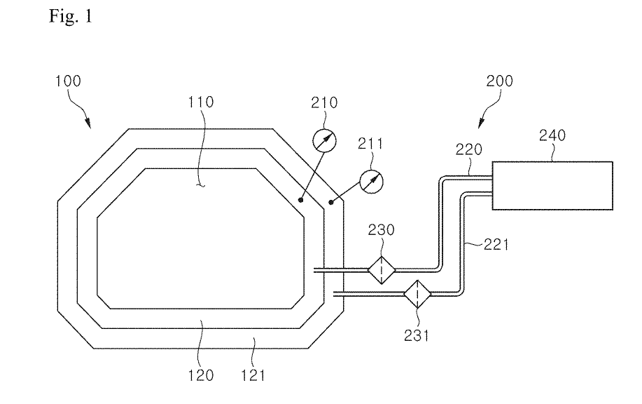

FIG. 1 is a schematic side view of an LNG storage tank and vacuum apparatus according to a first embodiment of the present invention.

Referring to FIG. 1, an LNG storage tank 100 includes: an internal space 110 in which LNG is stored; a primary heat-insulating layer 120 disposed to surround the internal space 110; and a secondary heat-insulating layer 121 disposed to surround the primary heat insulating layer 120.

Generally, the LNG storage tank 100 is constructed through a process in which the secondary heat-insulating layer 121 is disposed on a hull, a secondary sealing wall is disposed on the secondary heat-insulating layer, the primary heat-insulating layer 120 is disposed on the secondary sealing wall, and a primary sealing wall is disposed on the primary heat-insulating layer.

The primary sealing wall and the secondary sealing wall prevent LNG from flowing out of the storage tank 100, and the primary heat-insulating layer 120 and the secondary heat-insulating layer 121 insulate the internal space 110 from the outside to keep the temperature of the internal space 110 such that LNG stored in the internal space 110 is not vaporized.

The vacuum apparatus 200 according to this embodiment includes: a first vacuum gauge 210 measuring a pressure inside the primary heat-insulating layer 120; a second vacuum gauge 211 measuring a pressure inside the secondary heat-insulating layer 121; a first vacuum hose 220 having one end connected to the primary heat-insulating layer 120; a second vacuum hose 221 having one end connected to the secondary heat-insulating layer 121; a first vacuum filter 230 disposed on the first vacuum hose 220; a second vacuum filter 231 disposed on the second vacuum hose 221; and a vacuum pump 240 to which the other end of the first vacuum hose 220 and the other end of the second vacuum hose 221 are connected.

The first vacuum gauge 210 is connected to the primary heat-insulating layer 120 of the LNG storage tank 100 to measure the pressure inside the primary heat-insulating layer 120 and the second vacuum gauge 211 is connected to the secondary heat-insulating layer 121 of the LNG storage tank 100 to measure the pressure inside the secondary heat-insulating layer 121.

The pressures inside the heat-insulating layers 120, 121 of the LNG storage tank 100 can be checked in real time through the vacuum gauges 210, 211, respectively. Since the secondary heat-insulating layer 121 is formed to surround the primary heat-insulating layer 120, if the pressure of the primary heat-insulating layer 120 becomes lower than the pressure of the secondary heat-insulating layer 121, the storage tank 100 can be damaged. Therefore, in implementation of the present invention, it is very important to keep the pressure of the primary heat-insulating layer 120 higher than the pressure of the secondary heat-insulating layer 121. The vacuum gauges 210, 211 may be used to continuously check whether the pressure of the primary heat-insulating layer 120 is higher than the pressure of the secondary heat-insulating layer 121.

Herein, vacuum drying refers to a drying method of evaporating moisture of a material by lowering a pressure to a vapor pressure at which the moisture can evaporate. The pressures of the heat-insulating layers 120, 121 may be checked through the vacuum gauges 210, 211 to check whether the moisture evaporates well and to determine how long to perform drying.

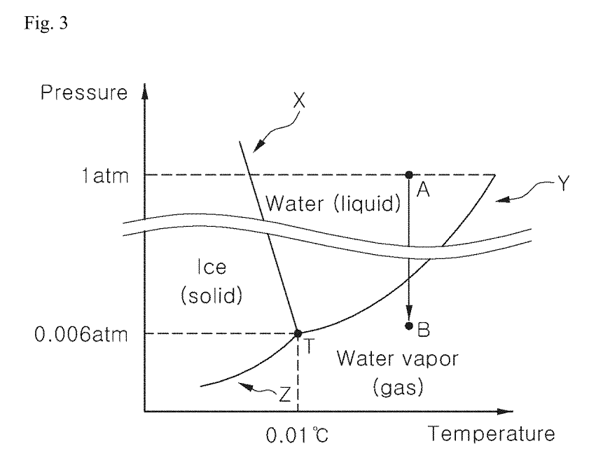

FIG. 3 is a state diagram of water according to changes in temperature and pressure.

Referring to FIG. 3, it can be seen that when the pressure is lower than the vapor pressure at a temperature higher than the temperature at the triple point (T) where the melting curve (X), the vapor pressure curve (Y), and the sublimation curve (Z) meet one another, (A) water in a liquid state turns into (B) vapor in a gaseous state. Vacuum drying is based on the fact that water can be vaporized by lowering the pressure at a given temperature.

In this embodiment, for efficient vacuum drying, the pressures inside the heat-insulating layers 120, 121 are adjusted to be lower than the vapor pressure but as close as possible to the vapor pressure.

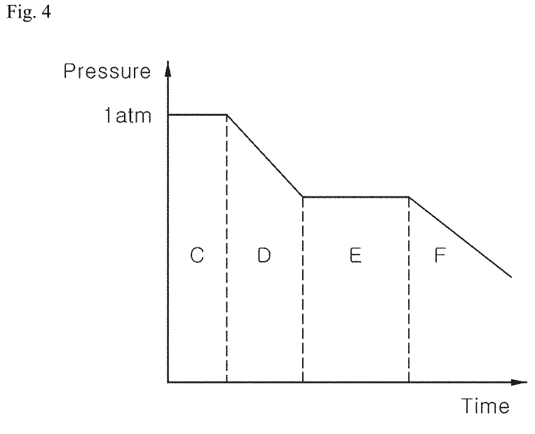

FIG. 4 is a graph depicting change in pressure inside a heat-insulating layer according to an exemplary embodiment of the present invention.

Referring to FIG. 4, the pressures inside the heat-insulating layers 120, 121 are substantially equal to the atmospheric pressure before vacuum drying according to this embodiment is performed (C). When vacuum drying according to this embodiment is performed (D), the pressures inside the heat-insulating layers 120, 121 are gradually reduced.

There is a section in which the pressures inside the heat-insulating layers 120, 121 are maintained almost constant (E) even when the vacuum apparatus 200 is continuously operated to reduce the pressures. This is because the pressures inside the heat-insulating layers 120, 121 becomes low enough to vaporize water such that moisture contained in plywood is evaporated into water vapor. That is, as the pressures inside the heat-insulating layers 120, 121 are reduced by the vacuum apparatus 200, the water vapor increases the pressures inside the heat-insulating layers 120, 121 such that the pressures inside the heat-insulating layers 120, 121 can be maintained substantially constant. When moisture contained in the plywood is almost completely evaporated, increase in the pressures inside the heat-insulating layers 120, 121 due to water vapor does not occur. As a result, the pressures inside the heat-insulating layers 120, 121 are reduced again (F).

Thus, if the pressures inside the heat insulating layers 120, 121 are maintained substantially constant (E) during continuous vacuum drying, this may mean that the moisture in the plywood is evaporating. In addition, since the moisture of the plywood evaporates while the pressures in the heat-insulating layers 120, 121 are maintained constant (E), the water content of the plywood can be controlled by adjusting a period of time for which the pressures in the heat-insulating layers 120, 121 are maintained substantially constant (E).

In other words, the pressures inside the heat-insulating layers 120, 121 may be checked through the vacuum gauges 210, 211 to determine whether moisture in the plywood is evaporating and to adjust the water evaporation time, thereby controlling the water content of the plywood.

In general, temperature is maintained constant when moisture is evaporating. However, since moisture in the plywood is evaporated in the LNG storage tank 100 having good thermal insulation herein, heat of vaporization for evaporation of the moisture in the plywood cannot be sufficiently supplied from the outside. If the heat of vaporization is not sufficiently supplied, the temperature of the plywood is reduced in the process of evaporating the moisture of the plywood. However, when the process of evaporating the moisture of the plywood is continued, the moisture of the plywood is reduced and the required heat of vaporization decreases, or the temperature difference between the inside and the outside of the plywood becomes large, such that heat supply is increased and the temperature of the plywood is increased again.

In some cases, the temperature of the plywood, which has been reduced during evaporation of the moisture of the plywood, cannot rise and continues to fall. When the temperature of the plywood falls below zero, the moisture inside the plywood becomes ice. Since sublimation of ice in the plywood into water vapor greatly increases vacuum drying time, when the temperature of the plywood falls below zero, warm gas needs to be supplied to increase the temperature.

Since vacuum is broken upon supply of the gas, a process of re-evacuating the inner sides of the heat-insulating layers 120, 121 is required. However, the process takes less time than a process of sublimating ice in the plywood into water vapor.

Preferably, the warm gas supplied when the temperature of the plywood falls below zero is an inert gas, such as argon (Ar), helium (He), or nitrogen (N₂). If air outside the heat-insulating layer is supplied as the warm gas, moisture contained in air can be absorbed by the plywood. In addition, the inert gas is less reactive with other materials and is thus safe. In general, nitrogen, which is inexpensive, is mainly used as the warm gas.

The vacuum hoses 220, 221 connect the vacuum pump 240 to the heat-insulating layers 120, 121 of the LNG storage tank 100 such that air inside the heat-insulating layers 120, 121 can escape into the vacuum pump 240 through the vacuum hoses 220, 221. One end of the first vacuum hose 220 is connected to the primary heat-insulating layer 120 and the other end of the first vacuum hose 220 is connected to the vacuum pump 240. In addition, one end of the second vacuum hose 221 is connected to the secondary heat-insulating layer 121 and the other end of the second vacuum hose 221 is connected to the vacuum pump 240.

The vacuum filter serves to filter out fine impurities drawn along with air through the vacuum hoses 220, 221. Particularly, when a particulate insulator is used, particles of the insulator can enter the vacuum hoses 220, 221. The vacuum filter filters out impurities such as the particles of the insulator to prevent the vacuum hoses 220, 221 from being blocked by the impurities or to prevent the vacuum pump 240 from failing. The first vacuum filter 230 is disposed on the first vacuum hose 220 and the second vacuum filter 231 is disposed on the second vacuum hose 221.

The vacuum pump 240 serves to draw air from the heat-insulating layers 120, 121 through the vacuum hoses 220, 221 each having the other end connected to the vacuum pump 240 to reduce the pressures inside the heat-insulating layers 120, 121. In this embodiment, the vacuum pump 240 is a common vacuum pump 240, to which both the first vacuum hose 220 connected to the primary heat-insulating layer 120 and the second vacuum hose 221 connected to the secondary heat-insulating layer 121 are connected.

In operation of the vacuum pump 240 according to this embodiment, air inside the primary heat-insulating layer 120 and air inside the secondary heat-insulating layer 121 are simultaneously discharged. Thus, in order to keep the internal pressure of the primary heat-insulating layer 120 higher than the internal pressure of the secondary heat-insulating layer 121, it is desirable that vacuum drying be performed in such a way that, after the second vacuum hose 221 is first connected to the vacuum pump 240 to reduce the pressure inside the secondary heat-insulating layer 121, the first vacuum hose 220 is further connected to the vacuum pump 240 to reduce the pressures in the primary heat-insulating layer 120 and the secondary heat-insulating layer 121 at the same time.

Alternatively, only the secondary heat-insulating layer 121 may be subjected to vacuum drying without applying vacuum drying to the primary heat-insulating layer 120 so as to keep the internal pressure of the primary heat-insulating layer 120 higher than the internal pressure of the secondary heat-insulating layer 121.

It some embodiments, the vacuum pump 240 may include a plurality of vacuum pumps. In these embodiments, both the first vacuum hose 220 and the second vacuum hose 221 are connected to each of the vacuum pumps 240.

In an embodiment wherein the vacuum pump 240 includes a plurality of vacuum pumps, the other end of the first vacuum hose 220 and the other end of the second vacuum hose 221 may be branched off into the same number of portions as the vacuum pumps 240 to be connected to the respective vacuum pumps 240, or the same number of first vacuum hoses 220 as the vacuum pumps and the same number of second vacuum hoses 221 as the vacuum pumps may be disposed such that the first vacuum hose 220 and the second vacuum hose 221 can be connected to the vacuum pumps 240 in a one-to-one manner.

In order to improve heat insulation of the LNG storage tank 100, the heat-insulating layers 120, 121 of the LNG storage tank 100 may be maintained under vacuum. Heat can be transferred by gas convection. Thus, the heat-insulating layers 120, 121 are maintained under vacuum such that external heat is prevented from being transferred to LNG inside the storage tank 100 by convection of a gas inside the heat insulating layers 120, 121.

It is desirable that an inert gas such as argon (Ar), helium (He) or nitrogen (N₂) be supplied into the heat-insulating layers 120, 121 even when the heat insulating layers 120, 121 are maintained under vacuum. If air outside the heat-insulating layer is supplied into the heat-insulating layers, moisture in the air can be absorbed by the plywood. Further, the inert gas is less reactive with other materials and is thus safe. In general, nitrogen, which is inexpensive, is mainly used.

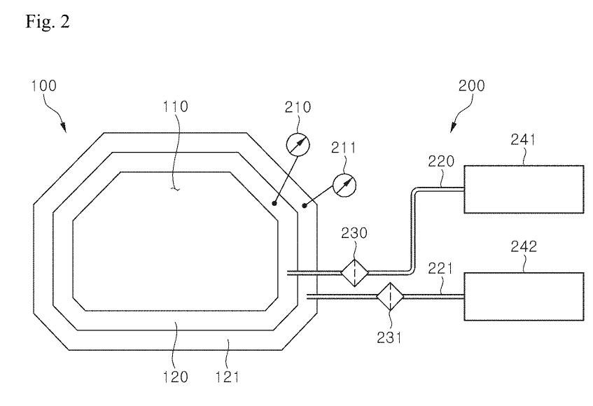

FIG. 2 is a schematic side view of an LNG storage tank and vacuum apparatus according to a second embodiment of the present invention.

Like the LNG storage tank 100 according to the first embodiment, the LNG storage tank 100 according to this embodiment includes: an internal space 110 in which LNG is stored; a primary heat-insulating layer 120 disposed to surround the internal space 110; and a secondary heat-insulating layer 121 disposed to surround the primary heat insulating layer 120.

In addition, like the vacuum apparatus 200 according to the first embodiment, the vacuum apparatus 200 according to this embodiment includes: a first vacuum gauge 210 measuring a pressure inside the primary heat-insulating layer 120; a second vacuum gauge 211 measuring a pressure inside the secondary heat-insulating layer 121; a first vacuum hose 220 having one end connected to the primary heat-insulating layer 120; a second vacuum hose 221 having one end connected to the secondary heat-insulating layer 121; a first vacuum filter 230 disposed on the first vacuum hose 220; a second vacuum filter 231 disposed on the second vacuum hose 221; and vacuum pumps 241, 242.

Unlike the vacuum pump 240 according to the first embodiment, the vacuum pumps 241, 242 according to this embodiment include two types of vacuum pumps, that is, a first vacuum pump 241 connected to the first vacuum hose 220 to draw air from the primary heat-insulating layer 120 and a second vacuum pump 242 connected to the second vacuum hose 221 to draw air from the secondary heat-insulating layer 121.

Thus, since the vacuum pumps 241, 242 according to this embodiment can separately draw air from the primary heat-insulating layer 120 and from the secondary heat-insulating layer 121, it is not necessary to connect the first vacuum hose 220 to the first vacuum pump 241 before connection of the second vacuum hose 221, as in the first embodiment. However, since the internal pressure of the primary heat-insulating layer 120 must be maintained to be higher than the internal pressure of the secondary heat-insulating layer 121, it is desirable that the first vacuum pump 241 and the second vacuum pump 242 be operated together after the first vacuum pump 242 is first operated.

Like the vacuum pump 240 according to the first embodiment, each of the vacuum pumps 241, 242 may include a plurality of vacuum pumps. In this case, the first vacuum hose 220 having one end connected to the primary heat-insulating layer 120 is connected to each of the plurality of first vacuum pumps 241, and the second vacuum hose 221 having one end connected to the secondary heat-insulating layer 121 is connected to each of the plurality of second vacuum pumps 242.

When each of the vacuum pumps 241, 242 includes a plurality of vacuum pumps, the first vacuum hose 220 may be branched off to be connected to the plurality of first vacuum pumps 241 and the second vacuum hose 221 may be branched off to be connected to the plurality of second vacuum pumps 240, or the same number of first vacuum hoses 220 as the first vacuum pumps 241 and the same number of second vacuum hoses 220 as the second vacuum pumps 242 may be disposed such that the first vacuum hoses 220 and the second vacuum hoses 221 can be respectively connected to the first vacuum pumps 241 and the second vacuum pumps 242 in a one to one manner.

Like the first vacuum gauge 210 according to the first embodiment, the first vacuum gauge 210 according to this embodiment is connected to the primary heat-insulating layer 120 of the LNG storage tank 100 to measure the pressure inside the primary heat-insulating layer 120, and, like the second vacuum gauge 211 according to the first embodiment, the second vacuum gauge 211 according to this embodiment is connected to the secondary heat-insulating layer 121 of the LNG storage tank 100 to measure the pressure inside the secondary heat-insulating layer 121.

Like the vacuum hoses 220, 221 according to the first embodiment, the vacuum hoses 220, 221 according to this embodiment connect the vacuum pumps 241, 242 to the heat-insulating layers 120, 121 of the LNG storage tank 100, respectively, such that air inside the heat-insulating layers 120, 121 can escape into the vacuum pumps 241, 242 through the vacuum hoses 220, 221.

However, one end of the first vacuum hose 220 according to this embodiment is connected to the primary heat-insulating layer 120 and the other end of the first vacuum hose 220 is connected to the first vacuum pump 241. In addition, one end of the second vacuum hose 221 is connected to the secondary heat-insulating layer 121 and the other end of the second vacuum hose 221 is connected to the second vacuum pump 242.

Like the vacuum filter according to the first embodiment, the vacuum filter according to this embodiment serves to filter out fine impurities drawn along with air through the vacuum hose 220, 221. In addition, the first vacuum filter 230 is disposed on the first vacuum hose 220 and the second vacuum filter 231 is disposed on the second vacuum hose 221.

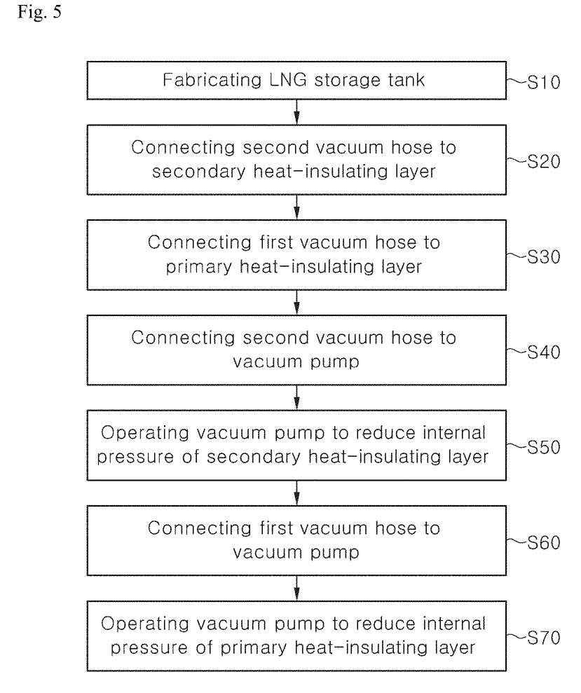

FIG. 5 is a flowchart of a method of reducing the boil-off rate of an LNG storage tank according to a first embodiment of the present invention.

Referring to FIG. 5, the method of reducing the boil-off rate of an LNG storage tank according to this embodiment includes: fabricating an LNG storage tank 100 (S10); connecting one end of a second vacuum hose 221 to a secondary heat-insulating layer 121 (S20); connecting one end of a first vacuum hose 220 to a primary heat-insulating layer 120 (S30); connecting the other end of the second vacuum hose 221 to a vacuum pump (S40); operating the vacuum pump to reduce the internal pressure of the secondary heat-insulating layer 121 (S50); connecting the other end of the first vacuum hose 220 to the vacuum pump (S60); and operating the vacuum pump to reduce the internal pressure of the primary heat-insulating layer 121 (S70).

In order to keep the internal pressure of the primary heat-insulating layer 120 higher than the internal pressure of the secondary heat-insulating layer 121 during operation of reducing the boil-off rate of an LNG storage tank according to this embodiment, it is desirable that connecting the other end of the first vacuum hose 220 to the vacuum pump (S60) be performed after connecting the other end of the second vacuum hose 221 to the vacuum pump (S40).

That is, after the other end of the second vacuum hose 221 is connected to the vacuum pump (S40) and the vacuum pump is operated to reduce the internal pressure of the secondary heat-insulating layer 121 to some extent (S50), the other end of the first vacuum hose 220 is connected to the vacuum pump (S60) and the vacuum pump is operated to reduce the internal pressures of the primary heat-insulating layer 120 and the secondary heat-insulating layer 121 at the same time (S70), or, after the other end of the second vacuum hose 221 is connected to the vacuum pump (S40) and the vacuum pump is operated to evacuate the inner side of the secondary heat-insulating layer 121 to a vacuum (S50), the other end of the first vacuum hose 220 is connected to the vacuum pump (S60) and the vacuum pump is operated to evacuate the inner side of the primary heat-insulating layer 121 to a vacuum (S70).

Alternatively, connecting one end of the first vacuum hose 220 to the primary heat-insulating layer 120 (S30), connecting the other end of the first vacuum hose 220 to the vacuum pump (S60), and operating the vacuum pump to reduce the internal pressure of the primary heat-insulating layer 121 (S70) may be omitted, such that vacuum drying can be applied to only the secondary heat-insulating layer 121 without applying vacuum drying to the primary heat-insulating layer 120.

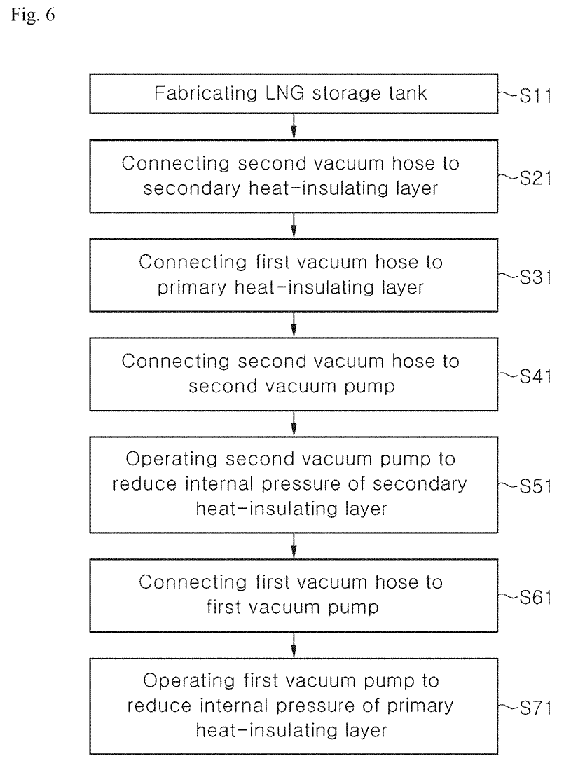

FIG. 6 is a flowchart of a method of reducing the boil-off rate of an LNG storage tank according to a second embodiment of the present invention.

Referring to FIG. 6, as in the method of reducing the boil-off rate of an LNG storage tank according to the first embodiment, the method of reducing the boil-off rate of an LNG storage tank according to this embodiment includes: fabricating an LNG storage tank 100 (S11); connecting one end of a second vacuum hose 221 to a secondary heat-insulating layer 121 (S21); connecting one end of a first vacuum hose 220 to a primary heat-insulating layer 120 (S31); connecting the other end of the second vacuum hose 221 to a vacuum pump (S41); operating the vacuum pump to reduce the internal pressure of the secondary heat-insulating layer 121 (S51); connecting the other end of the first vacuum hose 220 to the vacuum pump (S61); and operating the vacuum pump to reduce the internal pressure of the primary heat-insulating layer 121 (S71).

However, unlike the method of reducing the boil-off rate of an LNG storage tank according to the first embodiment, in this embodiment, two types of vacuum pumps, that is, a first vacuum pump 241 connected to the first vacuum hose 220 to draw air from the primary heat-insulating layer 120 and a second vacuum pump 242 connected to the second vacuum hose 221 to draw air from the secondary heat-insulating layer 121 are used. Thus, the other end of the second vacuum hose 221 is connected to the second vacuum pump 242 (S41), the second vacuum pump 242 is operated to reduce the internal pressure of the secondary heat-insulating layer 121 (S51), the other end of the first vacuum hose 220 is connected to the first vacuum pump 241 (S61), and the first vacuum pump 241 is operated to reduce the internal pressure of the primary heat-insulating layer 120 (S71).

In this embodiment, since the first vacuum hose 220 is connected to the first vacuum pump 241 and the second vacuum hose 221 is connected to the second vacuum pump 242, unlike the method of reducing the boil-off rate of an LNG storage tank according to the first embodiment, it is not necessary to connect the other end of the first vacuum hose 220 to the vacuum pump (S61) after connecting the other end of the second vacuum hose 221 to the second vacuum pump 242 (S41).

However, as in the method of reducing the boil-off rate of an LNG storage tank according to the first embodiment, in order to keep the internal pressure of the primary heat-insulating layer 120 higher than the internal pressure of the secondary heat-insulating layer 121 during operation of reducing the boil-off rate of an LNG storage tank according to this embodiment, after the second vacuum pump 242 is operated to reduce the internal pressure of the secondary heat-insulating layer 121 to some extent (S51), the first vacuum pump 241 and the second vacuum pump 242 are operated together to simultaneously reduce the internal pressures of the primary heat-insulating layer 120 and the secondary heat-insulating layer 121 (S71), or, after the second vacuum pump 242 is operated to evacuate the inner side of the secondary heat-insulating layer 121 to a vacuum (S51), the first vacuum pump 241 is operated to evacuate the inner side of the primary heat-insulating layer 120 to a vacuum (S71).

Further, as in the method of reducing the boil-off rate of an LNG storage tank according to the first embodiment, in the method according to this embodiment, connecting one end of the first vacuum hose 220 to the primary heat-insulating layer 120 (S31), connecting the other end of the first vacuum hose 220 to the vacuum pump (S61), and operating the vacuum pump to reduce the internal pressure of the primary heat-insulating layer 121 (S71) may be omitted such that vacuum drying can be applied to the secondary heat-insulating layer 121 without applying vacuum drying to the primary heat-insulating layer 120.

Although some embodiments have been described herein, it should be understood that these embodiments are provided for illustration only and are not to be construed in any way as limiting the present invention, and that various modifications, changes, alterations, and equivalent embodiments can be made by those skilled in the art without departing from the spirit and scope of the invention.

1. A method of reducing a boil-off rate of an LNG storage tank, comprising:
fabricating an LNG storage tank comprising a primary heat-insulating layer and a secondary heat-insulating layer;
connecting one end of a second vacuum hose to the secondary heat-insulating layer;
connecting the other end of the second vacuum hose to a vacuum pump; and
operating the vacuum pump to reduce an internal pressure of the secondary heat-insulating layer,
wherein an inner side of the secondary heat-insulating layer is evacuated to a vacuum to reduce a water content of plywood contained in the secondary heat-insulating layer.

2. The method according to claim 1, further comprising:
connecting one end of a first vacuum hose to the primary heat-insulating layer of the LNG storage tank;
connecting the other end of the first vacuum hose to the vacuum pump; and
operating the vacuum pump to reduce an internal pressure of the primary heat-insulating layer,
wherein an inner side of the primary heat-insulating layer is evacuated to a vacuum to reduce a water content of plywood contained in the primary heat-insulating layer, and an internal pressure of the primary heat-insulating layer is maintained to be higher than an internal pressure of the secondary heat-insulating layer during operation of reducing the boil-off rate of the LNG storage tank.

3. The method according to claim 2, wherein the vacuum pump comprises a plurality of vacuum pumps, each being connected to the other end of the first vacuum hose and the other end of the second vacuum hose.

4. The method according to claim 3, wherein the first vacuum hose and the second vacuum hose comprise the same number of first vacuum hoses as the vacuum pumps and the same number of second vacuum hoses as the vacuum pumps, respectively, such that the other ends of the first vacuum hoses and the other ends of the second vacuum hoses are connected to the vacuum pumps in a one-to-one manner.

5. The method according to claim 3, wherein one end of the first vacuum hose is connected to the primary heat-insulating layer; one end of the second vacuum hose is connected to the secondary heat-insulating layer; the other end of the first vacuum hose is branched off into the same number of portions as the vacuum pumps to be connected to the respective vacuum pumps; and the other end of the second vacuum hose is branched off into the same number of portions as the vacuum pumps to be connected to the respective vacuum pumps.

6. The method according to claim 2, wherein the other end of the first vacuum hose is connected to a first vacuum pump and the other end of the second vacuum hose is connected to a second vacuum pump.

7. The method according to claim 6, wherein the first vacuum pump and the second vacuum pump comprise a plurality of first vacuum pumps and a plurality of second vacuum pumps, respectively, and wherein each of the first vacuum pumps is connected to the other end of the first vacuum hose and each of the second vacuum pumps is connected to the other end of the second vacuum hose.

8. The method according to claim 7, wherein the first vacuum hose comprises the same number of first vacuum hoses as the first vacuum pumps such that the other ends of the first vacuum hoses are connected to the first vacuum pumps in a one-to-one manner, and the second vacuum hose comprises the same number of second vacuum hoses as the second vacuum pumps such that the other ends of the second vacuum hoses are connected to the second vacuum pumps in a one-to-one manner.

9. The method according to claim 7, wherein one end of the first vacuum hose is connected to the primary heat-insulating layer; one end of the second vacuum hose is connected to the secondary heat-insulating layer; the other end of the first vacuum hose is branched off into the same number of portions as the first vacuum pumps to be connected to the respective first vacuum pumps; and the other end of the second vacuum hose is branched off into the same number of portions as the second vacuum pumps to be connected to the respective second vacuum pumps.

10. The method according to claim 2, wherein the water content of plywood is controlled by adjusting a period of time for which internal pressures of the primary heat-insulating layer and the secondary heat-insulating layer are maintained constant.

11. The method according to claim 2, further comprising:
supplying a gas having a temperature higher than or equal to room temperature to the primary heat-insulating layer when a temperature of plywood contained in the primary heat-insulating layer drops below zero and supplying a gas having a temperature higher than or equal to room temperature to the secondary heat-insulating layer when a temperature of plywood contained in the secondary heat-insulating layer drops below zero.

12. The method according to claim 11, wherein the gas comprises any one of argon, helium, and nitrogen.

13. The method according to claim 2, wherein at least one of the primary heat-insulating layer and the secondary heat-insulating layer is maintained under vacuum after the water content of the plywood is reduced.

14. The method according to claim 2, further comprising: supplying a gas to at least one of the primary heat-insulating layer and the secondary heat-insulating layer after the water content of the plywood is reduced.

15. The method according to claim 14, wherein the gas comprises any one of argon, helium, and nitrogen.

16. A method of reducing a boil-off rate of an LNG storage tank, comprising:
fabricating an LNG storage tank comprising a heat-insulating layer;
connecting one end of a vacuum hose to the heat-insulating layer;
connecting the other end of the vacuum hose to a vacuum pump; and
operating the vacuum pump to reduce an internal pressure of the heat-insulating layer,
wherein an inner side of the heat-insulating layer is evacuated to a vacuum to reduce a water content of plywood contained in the heat-insulating layer.

17. A vacuum apparatus comprising:
a vacuum hose having one end connected to a heat-insulating layer of an LNG storage tank; and
a vacuum pump connected to the other end of the vacuum hose,
wherein the vacuum pump is operated to evacuate an inner side of the heat-insulating layer to a vacuum to reduce a water content of plywood contained in the heat-insulating layer.

18. The vacuum apparatus according to claim 17, further comprising: a vacuum gauge measuring a pressure inside the heat-insulating layer.

19. The vacuum apparatus according to claim 17, further comprising: a vacuum filter installed on the vacuum hose to filter out impurities.
